(19) United States
(12) Patent Application Publication
(10) Pub. No.: US 2020/0239757 A1
(43) Pub. Date: Jul. 30, 2020

(54) NANOFLUID

(71) Applicant: Dow Global Technologies LLC, Midland, MI (US)

(72) Inventors: Lalitha V. Ganapatibhotla, Pearland, TX (US); Stephen W. King, League City, TX (US); Michael T. Malanga, Midland, MI (US); John G. Pendergast, JR., Pearland, TX (US)

(21) Appl. No.: 15/754,933

(22) PCT Filed: Sep. 13, 2016
(86) PCT No.: PCT/US2016/051516

§ 371 Date: Feb. 23, 2018

Related U.S. Application Data
(60) Provisional application No. 62/219,399, filed on Sep. 16, 2015.

(51) Int. Cl. C09K 5/10; C01B 32/194

(52) U.S. Cl. CPC C09K 5/10; C01B 32/194; C01B 2204/24; C01B 2204/04; C01B 2204/02

(57) ABSTRACT

The present disclosure describes a nanofluid comprising a polar fluid medium; and a functionalized carbon nanomaterial. The present disclosure further describes a process for preparing a nanofluid comprising providing a functionalized carbon nanomaterial; providing a polar fluid medium; and dispersing the functionalized carbon nanomaterial in the polar fluid medium by ultrasonication.

### BACKGROUND OF THE INVENTION

Conventional heat transfer fluids such as water, mineral oil, and ethylene glycol play an important role in many industries including power generation, chemical production, air conditioning, transportation, and microelectronics. However, their inherently low thermal conductivities have hampered the development of energy-efficient heat transfer fluids that are required in a plethora of heat transfer applications. It has been demonstrated recently that the heat transfer properties of these conventional fluids can be significantly enhanced by dispersing or suspending nanometer-sized (about 1 to 100 nm in at least one dimension) solid particles and fibers (i.e. nanoparticles) in fluids. These dispersions and suspensions are referred to as nanofluids. Nanoparticles are typically made of chemically stable metals, metal oxides or carbon. Some nanofluids have been shown to substantially increase the heat transfer characteristics of the heat transfer fluid over the base fluid.

A nanofluid having improved heat transfer characteristics is desired.

### SUMMARY OF THE INVENTION

The present disclosure describes a nanofluid comprising a polar fluid medium; and a functionalized carbon nanomaterial. The present disclosure further describes a process for preparing a nanofluid comprising providing a functionalized carbon nanomaterial; providing a polar fluid medium; and dispersing the functionalized carbon nanomaterial in the polar fluid medium by ultrasonication.

### DETAILED DESCRIPTION OF THE INVENTION

As used herein, the term “carbon nanomaterial” refers to a nanomaterial which contains primarily carbon, for example, nanodiamond, graphite, fullerenes, carbon nanotubes, carbon fibers, and combinations thereof.

As used herein, the term “functionalized carbon nanomaterial” refers to an alkanolamineized form of a carbon nanomaterial.

As used herein, the term “alkanolamineized” refers to functionalizing a material with one or more alkanolamines or alkanolamine derivatives.

As used herein, “alkanolamine” refers to a hydrocarbon containing both a hydroxyl group and an amine group each attached to separate carbons. The alkanolamine may be a primary, secondary, or tertiary amine. The alkanolamine may be linear, branched, cyclic, aliphatic alkanolamine or aromatic alkanolamine.

The present disclosure describes a heat transfer fluid comprising a polar fluid medium and a functionalized carbon nanomaterial. In one instance, the heat transfer fluid is characterized as a suspension of functionalized carbon nanomaterials in the polar fluid medium. In one instance the heat transfer fluid contains dyes known to be used in coolant formulations. In one instance the heat transfer fluid contains corrosion inhibitors known to be used in coolant formulations.

In one instance, the polar fluid medium comprises a fluid that is polar. In one instance, the polar fluid medium comprises a fluid that is miscible in water. In one instance, the polar fluid medium comprises one or more glycols or diglycols. Glycol refers to a diol having two or more carbon atoms, and is referred to herein as a “mono glycol.” “Diglycol” also refers to a diol and is generally derived from two moles of an oxide for example, ethylene oxide, propylene oxide, and butylene oxide. As used herein, the generic “glycol” refers to either a mono glycol or a diglycol. In one instance the glycol includes branched carbon chains. In one instance the glycol includes straight carbon chains. In one instance, the polar fluid medium comprises water, straight chain mono glycols, branched chain mono glycols, straight chain diglycols, and branched chain diglycols, or a combination thereof. In one instance, the polar fluid medium comprises a solution of water and an organic salt, for example, potassium propionate. Examples of suitable polar fluid mediums include ethylene glycol, propylene glycol, diethylene glycol, dipropylene glycol, glycerol.

In one instance, the carbon nanomaterial is a one, two, or three dimensional material, as is known in the art. In one instance, the carbon nanomaterial is one or more of graphene, graphene oxide, reduced graphene oxide, single graphene or graphene oxide sheets or stacks of graphene or graphene oxide sheets, graphite, single-walled carbon nanotubes, multi-walled carbon nanotubes, carbon nanodiamonds, carbon nanoribbons, fullerenes, or other known carbon nanomaterials. In one instance, the carbon nanomaterial is sized 1 to 100 nm in at least one dimension. The graphene will include functional groups. In one instance, the functional groups of the graphene are carboxyl groups.

In one instance, the functional groups of the carbon nanomaterial are reacted to form a functionalized carbon nanomaterial. In one instance, the functionalized carbon nanomaterial is an alkanolamineized form of a carbon nanomaterial prepared using one or more alkanolamines. The alkanolamineized form of the carbon nanomaterial is prepared by reacting a carbodiimide activated carbon nanomaterial with the alkanolamine. In one instance, the alkanolamineized form of the carbon nanomaterial is prepared by reacting with diisopropylcarbodiimide (DIC), dimethylaminopropanol (DMAP), hydroxybenzotriazole (HOBt), and the alkanolamine in dimethylsulfoxide (DMSO), for example, by ultrasonication. In one instance, the carbodimide can be dicyclohexylcarbodiimide (DCC), or ethyl-(N′,N′-dimethylamino)propylcarbodiimide hydrochloride (EDC).

In one instance, the alkanolamine contains no more than twenty carbon atoms. In one instance, the alkanolamine contains two or more carbon atoms. In one instance, the alkanolamine has a straight carbon chain. In one instance, the alkanolamine has a branched carbon chain. The alkanolamine is selected such that it soluble in the polar fluid medium. In one instance, the alkanolamine is a polyetheramine, for example, those sold under the trade name Jeffamine monoamine (available from Huntsman Corp, molecular weight reported as up to 2000). In one instance, the alkanolamine is a piperazine derivative, for example, hydroxyethylpiperazine. In one instance, the alkanolamine is a cyclic alkanol amines, or an aromatic alkanol amine Examples of suitable alkanolamines include, but are not limited to, monoethanolamine, diethanolamine, monoisopropanolamine, and amino-methyl-propanols, for example, 2-amino-2-methyl-1-propanol.

In one instance, the nanofluid has improved thermal conductivity as compared to the polar fluid medium alone. In one instance, the thermal conductivity of the nanofluid is 2 to 150 percent higher than the polar fluid medium. In one instance, the nanofluid has increased viscosity as compared to the polar fluid medium. In one instance, the viscosity of the heat transfer fluid is 2 to 200 percent higher than the polar fluid medium. The nanofluid containing the functionalized carbon nanomaterial has improved dispersion stability as compared to a nanofluid containing unfunctionalized carbon nanomaterial, for example, as measured by the instability index. In one instance, the instability index, as measured using a LUMiSizer (available from LUM GmbH) of the nanofluid is 0 to 0.7. The stability of the dispersion increases as the dispersion instability approaches zero.

In one instance, the nanofluid further includes one or more additives, for example, a dispersant, a surfactant, a corrosion inhibitor, or a dye.

In one instance, the heat transfer fluid contains 0 to 100 weight percent glycol. In one instance, the heat transfer fluid contains 30 to 70 percent glycol by volume. In one instance, the heat transfer fluid contains 0 to 100 weight percent water. In one instance, the heat transfer fluid contains 30 to 70 percent water by volume. In one instance, the combination of the glycol and water in the heat transfer fluid is 90 to 99.99 weight percent of the heat transfer fluid. In one instance, the heat transfer fluid contains 0 to 100 weight percent water and organic salt. In one instance, the heat transfer fluid contains 0.001 to 10 weight percent functionalized carbon nanomaterial. In one instance, the heat transfer fluid contains less than 1 weight percent corrosion inhibitor. In one instance, the heat transfer fluid contains less than 1 weight percent dye. In one instance, the heat transfer fluid contains 40 to 60 weight percent glycol, 40 to 60 weight percent water, and 0.001 to 1 weight percent functionalized carbon nanomaterial.

In one instance, the heat transfer fluid is prepared by ultrasonication as is known in the art. For example, ultrasonication uses >20 kHz ultrasonic waves to create cavitation in the fluid that results in mixing and deaggregation. In one instance, the heat transfer fluid is prepared by high-shear mixing. For example, high-shear mixing uses a mixer which provides a high degree of shear to the fluid to disperse the nanoparticles in the fluid media. Ultrasonication is preferred for low-viscosity fluids while high-shear mixing is preferable for high-viscosity fluids. In one instance the heat transfer fluid is prepared at room temperature and pressure.

### Comparative Example 1

Nanofluid formulation with 0.1 wt % of graphene C-750 (available from XG-Sciences) dispersed in 50-50 vol % solution of ethylene glycol and water. The dispersion instability, as measured using a LUMiSizer® at 4000 rpm for 8 hours at 20° C. is 0.50.

### Example 1

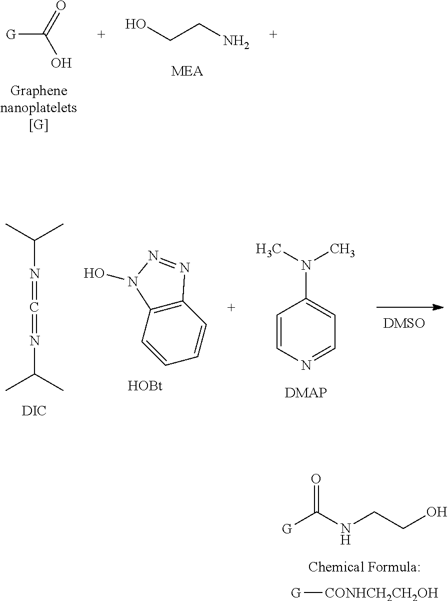

To a 100 mL round-bottom flask add 15 mL DMSO. Dissolve 252.4 mg DIC (available from Sigma Aldrich), 130 mg HOBt, 70 mg DMAP (available from Sigma Aldrich) into the DMSO (available from Sigma Aldrich). Stir the mixture for 15 minutes at room temperature. Add 450 mg graphene nanoplatelets [C-750 (available from XG-Sciences)] to the flask (where G represents the carbon structure of the graphene nanoplatelet) and stir for 10 minutes. Treat the flask contents with ultrasonication for 1 hour using a Branson ultra probe sonicator at 10% of the maximum available amplitude at room temperature and pressure. Add 450 mg monoethanolamine (MEA) (available from Sigma Aldrich) to the flask. Treat the flask contents with ultrasonication for 6 hours. Centrifuge the contents of the flask at 7800 rpm at 25 to 30° C. for 20 minutes. Remove the supernatant solution of graphene dispersion from the flask and separate the solvent using vacuum filtration with a PTFE membrane (0.45 μm cut off) (available from Millipore). Wash the black solid on the filter three times with dichloromethane (DCM, available from Sigma Aldrich) and three times with MeOH (available from Sigma Aldrich) and dry in a vacuum oven at 60° C. for one day. X-Ray photoelectron spectroscopy indicates that the graphene is functionalized as an amide of MEA. The dried amide functionalized C-750 graphene nanoplatelets are dispersed into 50-50 vol % Ethylene Glycol (available from Sigma Aldrich) and DI water mixture at 0.1 wt % loading using ultrasonication for 20 minutes at room temperature and pressure to make the graphene nanofluid. The dispersion instability of this nanofluid, as measured using a LUMiSizer® (manufactured by LUM GmbH) at 4000 rpm for 24 hours at 20° C. is 0.11 (for reference, an instability of 1 refers to a highly instable dispersion and an instability of 0 refers to a highly stable dispersion).

### Example 2

To a 100 mL round-bottom flask add 15 mL DMSO (available from Sigma Aldrich). Dissolve 252.4 mg DIC (available from Sigma Aldrich), 130 mg HOBt (available from Sigma Aldrich), 70 mg DMAP (available from Sigma Aldrich) into the DMSO. Stir the mixture for 15 minutes at room temperature. Add 450 mg graphene nanoplatelets to the flask (R10, available from XG Sciences, where G represents the carbon structure of the graphene nanoplatelet) and stir for 10 minutes. Treat the flask contents with ultrasonication for 1 hour using a Branson ultra probe sonicator at 10% of the maximum available amplitude at room temperature and pressure. Add 450 mg monoethanolamine (MEA) (available from Sigma Aldrich) to the flask. Treat the flask contents with ultrasonication for 6 hours. Centrifuge the contents of the flask at 7800 rpm at 25 to 30° C. for 20 minutes. Remove the supernatant solution of graphene dispersion from the flask and separate the solvent using vacuum filtration with a PTFE membrane (0.45 μm cut off). Wash the black solid on the filter three times with dichloromethane (DCM) (available from Sigma Aldrich) and three times with MeOH (available from Sigma Aldrich) and dry in a vacuum oven at 60° C. for one day. X-Ray photoelectron spectroscopy indicates that the graphene is functionalized as an amide of MEA. The dried amide functionalized R10 graphene nanoplatelets are dispersed into 50-50 vol % Ethylene Glycol (available from Sigma Aldrich) and DI water mixture at 2 wt % loading using ultrasonication for 20 minutes at room temperature and pressure to make the graphene nanofluid. The dispersion instability of the graphene nanofluid, as measured using a LUMiSizer® at 4000 rpm for 8 hours at 25° C., is 0.43. Percentage increase in Thermal conductivity with reference to 50-50 vol % ethylene glycol+DI water, as measured with Thermtest Transient Hot Wire equipment at 30° C., is 31.3%.

The same procedure described in this example was used to disperse as-received R10 graphene nanoplatelets (available from XG Sciences) at 2 wt % loading in 50-50 vol % ethylene glycol+DI water mixture. The dispersion instability, as measured using a LUMiSizer® at 4000 rpm for 8 hours at 25° C. is 0.88. Percentage increase in Thermal conductivity with reference to 50-50 vol % ethylene glycol+DI water, as measured with Thermtest Transient Hot Wire equipment at 30° C., is 39.9%.

1. A nanofluid comprising:
a polar fluid medium; and
a functionalized carbon nanomaterial, wherein the functionalized carbon nanomaterial comprises an alkanolamineized form of a carbon nanomaterial, wherein the alkanolamineized form of the carbon nanomaterial is prepared by reacting a carbodiimide activated carbon nanomaterial with an alkanolamine, wherein the carbon nanomaterial comprises a single graphene sheet or multiple graphene sheets.

2. The nanofluid of claim 1, wherein the polar fluid medium comprises a glycol, water, an organic salt, or a combination thereof.

3. (canceled)

4. The nanofluid of claim 1, wherein the nanofluid has improved thermal conductivity as compared to the polar fluid medium alone.

5. The nanofluid of claim 1, wherein the nanofluid containing the functionalized carbon nanomaterial has improved dispersion stability as compared to a nanofluid containing unfunctionalized carbon nanomaterial.

6. (canceled)

7. (canceled)

8. (canceled)

9. The nanofluid of claim 1, wherein the alkanolamine comprises one or more of straight chain alkanolamine, branched chain alkanolamine, polyetheramine, cyclic alkanol amines, aromatic alkanol amines, and piperazine derivatives.

10. The nanofluid of claim 2, wherein the glycol comprises one or more of straight chain mono glycols, branched chain mono glycols, straight chain diglycols, and branched chain diglycols.

11. The nanofluid of claim 1, further comprising a corrosion inhibitor.

12. The nanofluid of claim 1, wherein the functionalized carbon nanomaterial comprises 0.001 to 10 weight percent of the nanofluid.

13. A process for preparing a nanofluid comprising:
providing a functionalized carbon nanomaterial;
providing a polar fluid medium; and
dispersing the functionalized carbon nanomaterial in the polar fluid medium by ultrasonication.

14. The process of claim 9, wherein the functionalized carbon nanomaterial comprises an alkanolamineized form of a carbon nanomaterial.

15. The process of claim 9, the polar fluid medium comprises a glycol, water, an organic salt or a combination thereof.
